(19) United States
(12) Patent Application Publication
(10) Pub. No.: US 2022/0388920 A1
(43) Pub. Date: Dec. 8, 2022

(54) Urea-Formaldehyde Slow-Release Nitrogen Fertilizer And Manufacturing Method Thereof

(71) Applicants: Jianmin Hu, Zhengzhou (CN); Peikun Wan, Zhengzhou (CN); Jinzhe Hu, Zhengzhou (CN); Yuntao Bai, Zhengzhou (CN); Xiaoyong Liu, Zhengzhou (CN); Shumin Hu, Zhengzhou (CN)

(72) Inventors: Jianmin Hu, Zhengzhou (CN); Peikun Wan, Zhengzhou (CN); Jinzhe Hu, Zhengzhou (CN); Yuntao Bai, Zhengzhou (CN); Xiaoyong Liu, Zhengzhou (CN); Shumin Hu, Zhengzhou (CN)

(73) Assignee: ZHENGZHOU GAOFU FERTILIZER CO., LTD, Zhengzhou (CN)

(21) Appl. No.: 17/341,397

(22) Filed: Jun. 8, 2021

(51) Int. Cl. C05C 9/02; C05C 9/00; C05G 5/12; C05G 3/90; C05G 1/00; C05D 1/02; C05B 7/00; C05D 9/02

(52) U.S. Cl. CPC C05C 9/02; C05C 9/005; C05G 5/12; C05G 3/90; C05G 1/00; C05D 1/02; C05B 7/00; C05D 9/02

(57) ABSTRACT

A method for manufacturing a urea-formaldehyde slow-release nitrogen fertilizer includes steps of: mixing and heating urea and formaldehyde solution with a predetermined molar ratio of urea to formaldehyde; adjusting a PH value of hydroxymethylation reaction of urea and formaldehyde solution to 7.5-10.5; heating the hydroxymethylation reaction of urea and formaldehyde solution to the initial reaction temperature of 50° C.; adding a catalyst to start the hydroxymethylation reaction of urea and formaldehyde solution, and conducting hydroxymethylation reaction intermittently or continuously; heating cold urea-formaldehyde solution using the reaction heat of hydroxymethylation; adjusting the pH value of the methylenation reaction of urea and formaldehyde solution to 3.5-5.0; adding a catalyst; completing the methylenation reaction of urea and formaldehyde solution within 1 to 10 minutes; and performing spraying granulation of slurry after the methylenation reaction of urea and formaldehyde solution in the granulator to obtain a urea-formaldehyde slow-release nitrogen fertilizer.

### FIELD OF THE INVENTION

The present invention relates to a field of urea-formaldehyde slow-release fertilizers, especially to a method for manufacturing a novel urea-formaldehyde slow-release nitrogen fertilizer and a compound fertilizer thereof.

### BACKGROUND OF THE INVENTION

In 2012, the urea output is 65 million tons (converted to N100%, the output reached 30.38 million tons) in China, of which, about 51 million tons of urea is used for agriculture (converted to N100%, the output reached 23.46 million tons). The loss of urea accounts for 40% of the consumption. Together with other losses of nitrogen, the utilization rate of urea nitrogen in china is 35%-40%. Urea is a product with high energy consumption. In China, coals are used as raw materials to produce urea; with the global warming, there is a tremendous pressure to reduce carbon emissions. Therefore, developing a urea value-added technology is important to improve and increase the utilization rate of nitrogen fertilizers, which can make great contribution to reducing carbon emissions. Although various measures have been taken to enhance the nitrogen utilization and some slow-release fertilizers have been produced, there are rare low-cost slow-release fertilizers that can be promoted on a large scale in agriculture. At present, some compound fertilizer manufacturers produce urea-formaldehyde compound fertilizers in china, but they only use urea-formaldehyde as a granulation binder, or some manufacturers simply mix urea, formaldehyde solution, and dilute sulfuric acid without hydroxymethylation and methylenation reaction, and directly spray granulation. This type of products almost contains no cold water insoluble nitrogen, and cannot achieve the slow-release performance of urea-formaldehyde products, making users misunderstand the urea-formaldehyde slow-release fertilizer.

Based on years of research and experiences, it has been found that urea-formaldehyde slow-release nitrogen is the trend of slow-release nitrogen fertilizer, and its raw materials are easily available with low price. Urea is a nitrogen fertilizer that is easily dissolved in water, so it is easily lost with water. Related studies have showed that the loss of urea accounts for about 40% of its consumption. The urea-formaldehyde slow-release nitrogen fertilizer is mainly composed of monomethylol urea, dimethylol urea, monomethyl diurea, dimethyl diurea that can be soluble in 25±2° C. cold water (cold water soluble nitrogen, WSN, WN, CWSN or CWN for short), dimethyl triurea, trimethyl tetraurea that is insoluble in 25±2° C. cold water but soluble in 100±2° C. hot water (cold water insoluble nitrogen, WIN or CWIN for short), and urea formaldehyde polycondensates with longer chains that is insoluble in 100±2° C. hot water (hot water insoluble nitrogen, HWIN for short), such as tetramethylpentaurea and pentamethylhexaurea. Because most of the polycondensates are insoluble in water, nitrogen is not easily lost. These water-insoluble polycondensates are mainly decomposed by microorganisms in the soil to release the nitrogen they contain. However, if the content of polycondensates that are insoluble in hot water is too high, it is difficult to be decomposed to release nitrogen in the season, which cannot meet the needs for crop growth. Therefore, it is necessary to control the reaction conditions so that various components can meet the required proportions. According to years of research experiences at home and abroad, it is found that pure urea-formaldehyde slow-release nitrogen fertilizers should have the following technical indicators: total nitrogen of 38%-40%, activity index (AI for short) of 40 to 65, content of cold water insoluble nitrogen of 20%-32%, and content of hot water insoluble nitrogen of 18%-8%, and urea-formaldehyde polycondensate with a nitrogen content of 10%-18% that is insoluble in cold water at 25±2° C. but soluble in hot water at 100±2° C., to meet the needs of nitrogen for most crops.

The activity coefficient is the percentage of cold water insoluble nitrogen minus hot water insoluble nitrogen, divided by cold water insoluble nitrogen, that is, AI=(CWIN−HWIN)×100%/CWIN.

The real pure urea-formaldehyde slow-release nitrogen fertilizers should meet the above technical indicators; but these fertilizers have complicated production process and high production cost, so they are mainly used in industrial crops, flowers and golf course lawns in china or other countries in the world. Therefore, it is necessary to develop urea-formaldehyde slow-release fertilizer with simple process conditions and low production cost, which can be truly promoted in agriculture on a large scale. The products produced according to the method of the present invention can meet these requirements.

There are many patents on urea-formaldehyde slow-release compound fertilizers in China, but studies and actual investigations have found that they have some shortcomings.

The patent CN101391905A discloses a method for producing urea-formaldehyde fertilizer and urea-formaldehyde compound fertilizer. According to the method, a starch paste is made, and then formaldehyde and urea are added to the starch paste to react under alkaline conditions. After reaction for a period of time, an adsorbent and sulfuric acid solution are added to the solution, mixed well to obtain the urea-formaldehyde fertilizer slurry, and then solidified to get urea-formaldehyde fertilizer. For this invention, the starch paste should be prepared first, and then formaldehyde and urea are added, but the heating method is not mentioned, and how to maintain the reaction temperature at 60° C.-80° C. by releasing the reaction heat; and in the second step, the adsorbent needs to be added to make solidified product with water content of 5%-40%. The curing agent is added to reduce the moisture content, but it also reduces the content of total nitrogen. Because the reaction heat released during the polymerization process is not fully utilized, the drying of the prepared particles will consume a large amount of energy. In addition, its production process is relatively complicated, and the heat released by the reaction process is not fully utilized, with high production cost, so the subsequent production cost of compound fertilizers will be increased.

The Chinese patent CN1343186A discloses the preparation of a granular compound fertilizer composition. By applying a liquid mixture of urea and formaldehyde to a dry substrate, phosphorus source, potassium source, auxiliary nutrient source, micronutrient source or mixtures thereof, the liquid mixture reacts to form a methylene urea reactant, thereby promoting the adhesion of the substrate and particle compound. The substrate is granulated while the liquid mixture is reacted. Its existing problem is that, the solution after the first step of hydroxymethylation reaction is sprayed to phosphorus source, potassium source or composite substrate, and at the same time, diluted sulfuric acid is sprayed to make the methylenation polymerization reaction to proceed on the substrate. Due to the presence of the substrate, it is difficult to control the progress of the methylenation reaction, and the fertilizers produced have no stable quality.

The Chinese patent CN102153392A discloses a method for producing a novel slow-release urea-formaldehyde compound fertilizer. According to the method, in combination with the traditional production process of sulfuric acid replacement of potassium chloride to produce sulfur-based compound fertilizer, a part of urea-formaldehyde slow-release nitrogen is introduced, so that the compound fertilizer has slow-release property. The defect of the invention is that the product is insoluble in cold water at 25±2° C. but soluble in hot water at 100±2° C., and the nitrogen content is not easy to control, and the ratio of CWN, CWIN, and HWIN slow-release components is not easy to control, and the quality is not stable. This production method has some limitations.

The patent CN101857513A discloses a method for preparing long-acting slow-release compound fertilizer by one-step spray granulation. The hot solution of urea and formaldehyde is mixed with sulfuric acid in the pipeline, and then sprayed into a granulator with solid materials such as nitrogen, phosphorus, potassium or fillers for granulation. Although this method has a simple process, methylenation reaction cannot be carried out because of absence of hydroxymethylation reaction. The contents of CWN, CWIN, and HWIN cannot be controlled, and there is almost no nitrogen that is neither soluble in cold water nor hot water. The product almost has no slow action of has no ideal slow action of urea-formaldehyde slow-release fertilizers.

The patent CN103214312A discloses a high molar ratio of urea-formaldehyde slow-release fertilizer and preparation method thereof. Its process is relatively complicated, with long reaction cycle and high energy consumption.

### SUMMARY OF THE INVENTION

The object of the present invention is to provide a urea-formaldehyde slow-release fertilizer with low production cost, stable slow-release performance, easy control of the proportion of components and simple production process, so that qualified urea-formaldehyde slow-release fertilizers can be truly extended to agriculture, to reduce expenditures and increase incomes for farmers, and make contributions to the reduction of carbon emissions.

The present invention provides a method for producing a novel urea-formaldehyde slow-release nitrogen fertilizer and compound fertilizer thereof. It can produce pure powdered or granular urea-formaldehyde slow-release nitrogen fertilizer with ideal ratio of CWN, CWIN and HWIN, and also produce urea-formaldehyde compound fertilizer containing nitrogen, phosphorus, potassium and trace nutrients. For the production of pure urea-formaldehyde slow-release nitrogen fertilizer, it is mainly to control the ratio of urea and formaldehyde solution, and process conditions such as temperature, PH value, reaction time, and make full use of the heat released by the reactions, to produce an ideal slow-release urea-formaldehyde product through one-step or multi-step spray drying or spray granulation.

The production method of compound fertilizer containing urea-formaldehyde slow-release nitrogen fertilizer is to produce compound fertilizers containing nitrogen, phosphorus, potassium and medium and micronutrient elements by conventional granulation methods in one step or multiple steps such as drum granulation, spray granulation, disc granulation, tower granulation, etc. The content ratio of nitrogen, phosphorus and potassium is almost unlimited.

The principle of the technical solutions for producing pure urea-formaldehyde slow-release nitrogen fertilizer is as follows:

At the beginning of the reaction, urea, 30%-50% formaldehyde, catalyst and caustic soda solution or other alkaline solution are added to a reactor or a specially designed reaction vessel at a certain molar ratio according to the ratio of all components and activity coefficient, heated while dissolving, to reach the initial reaction temperature. After the reaction starts, heating is stopped, and reaction materials are continuously added, and the heat released from the reactions is used to heat the newly added materials, to reach the initial reaction temperature. If the temperature does not reach the initial reaction temperature, materials can be heated appropriately. In this way, the reaction heat is fully utilized to heat the newly added materials, and at the same time, the newly added materials take away the heat released by the hydroxymethylation reaction, to control the reaction temperature and minimize the energy consumption. After the hydroxymethylation is completed, catalyst and dilute sulfuric acid (acids such as hydrochloric acid, nitric acid) are added, to control the PH value, to achieve quick methylenation of reacting materials within 1 to 10 min, and then perform spray drying or spray granulation, to obtain pure slow-release urea-formaldehydenitrogen fertilizer with a certain ratio of components and activity coefficient. Since the heat released by the hydroxymethylation and methylenation reactions is fully utilized, there is no need to cool using cooling water or other cooling media; in addition, the reaction time is short, lowering the energy consumption for synthesis and drying and reducing the production cost.

According to the technical solutions, a catalyst can be added step by step to adjust the PH value under continuous reaction; or a catalyst can be added step by step to adjust the PH value under reactions step by step. The hydroxymethylation reaction temperature is between 50° C. and 75° C., the pH value is between 7.5 and 10.5, and the molar ratio of urea to formaldehyde is within the range of 1.5-2.5:1. The PH value of methylenation is adjusted continuously before the start of methylenation. The pH value is in the range of 3.5-5.0, the reaction time is 1 minute to 10 minutes, there is no need to cooling. In addition, it makes full use of the heat that should be released, and the drying time is short, reducing the energy consumption required for drying. Methylenation and spray drying or spray granulation are performed continuously. By flexibly adjusting the molar ratio of urea and formaldehyde, the compositions and amount of addition of catalyst, the material PH and the reaction temperature, it is easy to produce products with stable and reliable quality and ideal component ratio and activity coefficient.

The principle of the technical solutions for producing compound fertilizer containing a certain proportion of urea-formaldehyde slow-release nitrogen fertilizer is as follows:

Production by a drum granulator. According to the fertilizer specification to be produced, a certain proportion of potash fertilizer, phosphate fertilizer, nitrogen fertilizer and medium and micronutrient elements are added continuously, and a certain proportion of urea-formaldehyde slurry that completes the methylenation reaction is sprayed. Through the adhesive action of the slurry, materials are bonded and granulated, without the need for steam, water or other adhesives. At the same time, drying, cooling, and sieving are carried out, to produce granular compound fertilizer with a certain amount of urea-formaldehyde slow-release nitrogen, with unlimited nitrogen content. The product has stable quality, good slow-release performance, uniform particles, good strength, and it is not easy to agglomerate, with low production cost.

Production by a disc granulator. According to the fertilizer specification to be produced, a certain proportion of potash fertilizer, phosphate fertilizer, nitrogen fertilizer and medium and micronutrient elements are added continuously, and a certain proportion of urea-formaldehyde slurry that completes the methylenation reaction is sprayed. Through the adhesive action of the slurry, materials are bonded and granulated, without the need for steam, water or other adhesives. The resulting products can reach the same quality as those made by a drum granulator.

More specifically, the present invention adopts the following technical solutions.

A method for producing a novel urea-formaldehyde slow-release nitrogen fertilizer, comprising the following steps:

(1) mixing urea and formaldehyde solution and heating, with a molar ratio of urea to formaldehyde at (1.5-2.5):1;

(2) adjusting a PH value of hydroxymethylation reaction of urea and formaldehyde solution to 7.5-10.5;

(3) heating the hydroxymethylation reaction of urea and formaldehyde solution to the initial reaction temperature of 50° C.;

(4) adding a catalyst to start the hydroxymethylation reaction of urea and formaldehyde solution, and conducting hydroxymethylation reaction intermittently or continuously;

(5) heating cold urea-formaldehyde solution using the reaction heat of hydroxymethylation, and heating appropriately if the temperature cannot reach the initial reaction temperature;

(6) adjusting the pH value of the methylenation reaction of urea and formaldehyde solution to 3.5-5.0;

(7) adding a catalyst, without controlling the temperature of materials for methylenation reaction;

(8) completing the methylenation reaction of urea and formaldehyde solution in a reaction vessel within 1 min to 10 min;

(9) directly performing spraying granulation of slurry after the methylenation reaction of urea and formaldehyde solution in the granulator, to obtain a urea-formaldehyde slow-release nitrogen fertilizer.

The urea in step (1) is a solid urea, or a urea solution of intermediate product in the production process of a urea factory, and the concentration of the urea solution is ≥90%; the concentration of formaldehyde solution is 30% to 50%.

The substance for adjusting the pH value is sodium hydroxide and solution thereof, or alkaline dissolved matter such as borax in step (2).

The temperature of hydroxymethylation reaction of the urea and the formaldehyde solution in step (3) is between 50° C. and 75° C.

The hydroxymethylation reaction of the urea and formaldehyde solution in step (4) is carried out in a reactor, and the reaction in the reactor can be performed intermittently one by one or continuously by reactors in series.

In the reaction of step (5), when the urea and formaldehyde solution react for the first time and restart reaction after suspension each time, the urea and formaldehyde solution are heated to the initial reaction temperature of 50° C., and not heated when reacting stably, or the heating intensity is reduced, and the heat released by the hydroxymethylation reaction is taken away by the cold urea-formaldehyde solution while heating the cold urea-formaldehyde solution.

The pH value of methylenation reaction in step (6) is between 3.5 and 5.0, and the pH value is adjusted by acidic substances such as sulfuric acid, nitric acid, hydrochloric acid, acetic acid, and oxalic acid.

The temperature of materials of methylenation reaction is not controlled and no cooling measures are taken in step (7), to make full use of the reaction heat and reduce the energy consumption for drying.

The methylenation reaction of the urea and formaldehyde solution of step (8) is completed within 1 min to 10 min, with very short time.

The methylenation reaction slurry of urea and formaldehyde solution in step (8) is directly spray-dried in a drying apparatus to obtain powdered urea-formaldehyde slow-release nitrogen fertilizer.

The materials completed by the hydroxymethylation reaction are stored in a storage tank, and then methylenation is carried out according to production needs; or methylenation is carried out directly after hydroxymethylation.

A method for producing a novel compound fertilizer of urea-formaldehyde slow-release nitrogen fertilizer, wherein the methylenation reaction slurry in step (8) of claims 1 to 11 is added with raw materials containing other nutrient elements to produce a compound fertilizer.

The raw materials containing other nutrient elements are urea, ammonium nitrate, ammonium sulfate, ammonium chloride, liquid ammonia, molten urea liquid, powder urea-formaldehyde in nitrogen fertilizers, and a variety of calcium superphosphate, monoammonium or diammonium phosphate, calcium magnesium phosphate in phosphate fertilizers, and potassium sulfate, potassium chloride, potassium carbonate, and potassium hydrogen sulfate solution with sulfuric acid replacing potassium chloride in potash fertilizers; and the production apparatus is a drum granulator, a disc granulator, or a tower granulator.

The present invention has the following advantages. Compared with the existing production technology of urea-formaldehyde compound fertilizers, the process of the invention is simple and the energy consumption is low, the slow-release components and the activity coefficient can be adjusted arbitrarily within the ideal range, and the content of nutrient elements is not limited by the process conditions, especially the nitrogen content is not limited. The product has stable quality, good slow-release performance, uniform particles, good strength, and it is not easy to agglomerate and its production cost is low, therefore, it is suitable for promotion in large area in agriculture.

### DETAIL DESCRIPTION OF PREFERRED EMBODIMENTS OF THE INVENTION

The present invention will be further described below in conjunction with specific embodiments.

### Example 1

To a special reaction vessel, urea and 50% formaldehyde solution were evenly added at a molar ratio of 2.5:1, mixed to dissolve while heating, when the temperature reached 50° C., a catalyst and 25% sodium hydroxide solution were added to adjust the pH value to 7.5, then stirred continuously and cooled, to maintain the temperature at about 50° C. and stir for 35 minutes to carry out the hydroxymethylation reaction. Then the catalyst and 20% dilute sulfuric acid were added to adjust the PH value to 3.5, stirred for 1 minute for methylenation reaction, and then spray-dried to obtain pure slow-release urea-formaldehyde powder. Product indicators were as follows: total nitrogen 39.3%, of which cold water-soluble nitrogen (CWN) 11.9%, cold water insoluble nitrogen (CWIN) 27.6%, hot water insoluble nitrogen (HWIN) 12.7%, and activity coefficient (AI) 40%.

### Example 2

To a special reaction vessel, urea and 30% formaldehyde solution were evenly added at a molar ratio of 1.5:1, dissolved while heating, and catalyst and 30% sodium hydroxide solution were added evenly, to control the material PH at 10.5, when the temperature reached 50° C., the control valve of the reaction vessel was opened, so that the materials reacted while flowing in the reaction vessel, and at the same time, urea, formaldehyde solution, catalyst, sodium hydroxide solution were added continuously according to a proportion. When the initially added material started to heat the later added material, the heating was reduced or stopped according to the temperature change, and the temperature was controlled at 75° C. for hydroxymethylation reaction. When the temperature of the initially added material started to decrease, the catalyst and 20% dilute sulfuric acid were added evenly according to the material flow rate and PH value from another feeding port, to control the PH value at 5, after methylenation reaction for 10 minutes, the slurry was sprayed to a granulation dryer to dry and granulate. The materials out of the granulator were sieved, and the sieved fine materials were sent back to the granulator again to continue granulation. The large materials were crushed to return to the granulator for re-granulation. The products with qualified particles were cooled and packed, to obtain qualified pure granular urea-formaldehyde slow-release nitrogen fertilizer. The indicators of pure granular urea-formaldehyde slow-release nitrogen fertilizers were as follows: total nitrogen 39.8%, of which cold water-soluble nitrogen (CWN) 17.0%, cold water insoluble nitrogen (CWIN) 22.7%, hot water insoluble nitrogen (HWIN) 9.7%, activity coefficient (AI) 65%.

### Example 3

The following materials were mixed evenly and added to a spray granulating dryer evenly according to the amount added per hour: 1200 kg of potassium sulfate powder containing 50% potassium oxide, 680 kg of 11-44-0 monoammonium phosphate powder, 250 kg of urea with 46% nitrogen, 995 kg of dolomite powder, 50 kg of ferrous sulfate monohydrate, and 25 kg of zinc sulfate monohydrate). At the same time, the methylenation slurry produced in Example 2 was evenly sprayed into the spray granulation dryer at a rate of 3,000 kg/hour. Under the condition of continuous production, 5 tons of compound fertilizers containing urea-formaldehyde slow-release nitrogen with specification of 18-6-12 were produced per hour. In the 18% total nitrogen, there were ammonium nitrogen 1.5%, urea nitrogen 2.5%, urea-formaldehyde nitrogen 14.0% (of which cold water insoluble nitrogen 8.0%, hot water insoluble nitrogen 3.4%).

### Example 4

To a special reaction vessel, urea and 40% formaldehyde solution were evenly added at a molar ratio of 2:1, at the same time, 30% sodium hydroxide solution and catalyst were added evenly to adjust PH at 9.8. The added amount of sodium hydroxide solution and catalyst was maintained stable and uniform, and the reaction temperature was controlled at 60° C. for hydroxymethylation reaction. When the hydroxymethylation reaction was basically completed, 20% dilute sulfuric acid and the catalyst were added to maintain the PH value of 4. After methylenation reaction for 10 minutes, the slurry was sprayed to a granulation dryer to dry and granulate. The materials out of the granulator were sieved, and the sieved fine materials were sent back to the granulator again to continue granulation. The large materials were crushed to return to the granulator for re-granulation. The products with qualified particles were cooled and packed, to obtain qualified pure granular urea-formaldehyde slow-release nitrogen fertilizer. The indicators of pure granular urea-formaldehyde slow-release nitrogen fertilizers were as follows: total nitrogen 38.7%, of which cold water-soluble nitrogen (CWN) 11.4%, cold water insoluble nitrogen (CWIN) 27.3%, hot water insoluble nitrogen (HWIN) 13.6%, activity coefficient (AI) 50.2%.

### Example 5

To a two-ton reactor, 1,300 kg of urea particles and 950 kg of 50% formaldehyde solution were added, heated while stirring, and at the same time, a catalyst and 30% sodium hydroxide solution were added to adjust the pH to 9.5. When the temperature rose to 50° C., heating was stopped. After reaction started, the temperature was maintained at 65° C. for hydroxymethylation reaction. When the temperature was stable or started to drop, the slurry was introduced into the tubular reactor. At the same time, the catalyst and 20% sulfuric acid solution were added, to adjust PH to 4.2. After the methylenation reaction lasted 8 minutes, the slurry was sprayed into the spray dryer to obtain pure powdered urea-formaldehyde slow-release nitrogen fertilizer. The obtained product indicators were as follows: total nitrogen 38.3%, cold water insoluble nitrogen 25.6%, hot water insoluble nitrogen 14.4%, and activity coefficient 43.8%.

### Example 6

The following materials were evenly placed into a drum granulator: 250 kg of powdered urea-formaldehyde slow-release nitrogen fertilizer produced in Example 5, 210 kg of granular urea, 250 kg of 60% potassium chloride powder, 225 kg of 11-44-0 monoammonium phosphate powder, 65 kg of dolomite powder, to produce a compound fertilizer containing urea-formaldehyde slow-release nitrogen with a specification of 20-10-15, of which, the cold water insoluble nitrogen was 6.4%, and hot water insoluble nitrogen was 3.6%.

### Example 7

According to the traditional production process of sulfuric acid replacement of potassium chloride to produce sulfur-based compound fertilizer, urea-formaldehyde slow-release nitrogen was sprayed to produce sulfur-based urea-formaldehyde slow-release compound fertilizer. The specific method was as follows: concentrated sulfuric acid with a concentration of 98% was uniformly added to the reaction tank at a flow rate of 3.95 m³/h, and potassium chloride containing 60% potassium oxide was added to the reaction tank at an amount of 8 tons/hour to mix and stir, to produce potassium hydrogen sulfate slurry with a specific gravity of about 1.8 g/ml.

The previously prepared potassium hydrogen sulfate solution and 20% dilute phosphoric acid were mixed to produce mixed slurry, with a specific gravity of 1.4 g/ml. Then ammonia was added to neutralize, with a degree of neutralization of 1.2. The methylenation slurry prepared according to Example 5 and the neutralized mixed acid slurry were sprayed into the drum granulation dryer at the same time, to prepare the slow-release urea-formaldehyde compound fertilizer containing nitrogen, phosphorus and potassium. By changing the spraying ratio of mixed acid and methylenation slurry, compound fertilizers with different ratios of nitrogen, phosphorus and potassium could be produced.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method for manufacturing a urea-formaldehyde slow-release nitrogen fertilizer, comprising steps of:
(1) mixing urea and formaldehyde solution and heating, with a molar ratio of urea to formaldehyde at (1.5-2.5):1;
(2) adjusting a PH value of hydroxymethylation reaction of urea and formaldehyde solution to 7.5-10.5;
(3) heating the hydroxymethylation reaction of urea and formaldehyde solution to the initial reaction temperature of 50° C.;
(4) adding a catalyst to start the hydroxymethylation reaction of urea and formaldehyde solution, and conducting hydroxymethylation reaction intermittently or continuously;
(5) heating cold urea-formaldehyde solution using the reaction heat of hydroxymethylation, and heating appropriately if the temperature cannot reach the initial reaction temperature;
(6) adjusting the pH value of the methylenation reaction of urea and formaldehyde solution to 3.5-5.0;
(7) adding a catalyst, without controlling the temperature of materials for methylenation reaction;
(8) completing the methylenation reaction of urea and formaldehyde solution in a reaction vessel within 1 min to 10 min;
(9) directly performing spraying granulation of slurry after the methylenation reaction of urea and formaldehyde solution in the granulator, to obtain a urea-formaldehyde slow-release nitrogen fertilizer.

2. The method for manufacturing a urea-formaldehyde slow-release nitrogen fertilizer according to claim 1, wherein the urea in step (1) is a solid urea, or a urea solution of intermediate product in the production process of a urea factory, and the concentration of the urea solution is >90%; the concentration of formaldehyde solution is 30% to 50%.

3. The method for manufacturing a urea-formaldehyde slow-release nitrogen fertilizer according to claim 1, wherein the substance for adjusting the pH value is sodium hydroxide and solution thereof, or alkaline dissolved matter such as borax in step (2).

4. The method for manufacturing a urea-formaldehyde slow-release nitrogen fertilizer according to claim 1, wherein the temperature of hydroxymethylation reaction of the urea and the formaldehyde solution in step (3) is between 50° C. and 75° C.

5. The method for manufacturing a urea-formaldehyde slow-release nitrogen fertilizer according to claim 1, wherein the hydroxymethylation reaction of the urea and formaldehyde solution in step (4) is carried out in a reactor, and the reaction in the reactor can be performed intermittently one by one or continuously by reactors in series.

6. The method for manufacturing a urea-formaldehyde slow-release nitrogen fertilizer according to claim 1, wherein in the reaction of step (5), when the urea and formaldehyde solution react for the first time and restart reaction after suspension each time, the urea and formaldehyde solution are heated to the initial reaction temperature of 50° C., and not heated when reacting stably, or the heating intensity is reduced, and the heat released by the hydroxymethylation reaction is taken away by the cold urea-formaldehyde solution while heating the cold urea-formaldehyde solution.

7. The method for manufacturing a urea-formaldehyde slow-release nitrogen fertilizer according to claim 1, wherein the pH value of methylenation reaction in step (6) is between 3.5 and 5.0, and the pH value is adjusted by acidic substances such as sulfuric acid, nitric acid, hydrochloric acid, acetic acid, and oxalic acid.

8. The method for manufacturing a urea-formaldehyde slow-release nitrogen fertilizer according to claim 1, wherein the temperature of materials of methylenation reaction is not controlled and no cooling measures are taken in step (7), to make full use of the reaction heat and reduce the energy consumption for drying.

9. The method for manufacturing a urea-formaldehyde slow-release nitrogen fertilizer according to claim 1, wherein the methylenation reaction of the urea and formaldehyde solution of step (8) is completed within 1 min to 10 min, with very short time.

10. The method for manufacturing a urea-formaldehyde slow-release nitrogen fertilizer according to claim 1, wherein the methylenation reaction slurry of urea and formaldehyde solution in step (8) is directly spray-dried in a drying apparatus to obtain powdered urea-formaldehyde slow-release nitrogen fertilizer; or the methylenation reaction slurry is sprayed and granulated directly in a granulator to obtain granular urea-formaldehyde slow-release nitrogen fertilizer.

11. The method for manufacturing a urea-formaldehyde slow-release nitrogen fertilizer according to claim 10, wherein the materials completed by the hydroxymethylation reaction are stored in a storage tank, and then methylenation is carried out according to production needs; or methylenation is carried out directly after hydroxymethylation.

12. The method for manufacturing a urea-formaldehyde slow-release nitrogen fertilizer according to claim 1, wherein the methylenation reaction slurry in step (8) of claim 1 is added with raw materials containing other nutrient elements to produce a compound fertilizer.

13. The method for manufacturing a urea-formaldehyde slow-release nitrogen fertilizer according to claim 12, wherein the raw materials containing other nutrient elements are urea, ammonium nitrate, ammonium sulfate, ammonium chloride, liquid ammonia, molten urea liquid, powder urea-formaldehyde in nitrogen fertilizers, and a variety of calcium superphosphate, monoammonium or diammonium phosphate, calcium magnesium phosphate in phosphate fertilizers, and potassium sulfate, potassium chloride, potassium carbonate, and potassium hydrogen sulfate solution with sulfuric acid replacing potassium chloride in potash fertilizers; and the production apparatus is a drum granulator, a disc granulator.
